(19) United States
(12) Patent Application Publication
(10) Pub. No.: US 2003/0036866 A1
(43) Pub. Date: Feb. 20, 2003

(54) System and method for creating a test executive sequence to perform display inspection

(76) Inventors: Dinesh Nair, Austin, TX (US); Joseph Pearson, Cedar Park, TX (US); Marc Marini, New Brauntels, TX (US)

Correspondence Address: Jeffrey C. Hood, Conley, Rose, & Tayon, P.C., P.O. Box 398, Austin, TX, 78767, US

(21) Appl. No.: 10/080,017

(22) Filed: Feb. 19, 2002

Related U.S. Application Data
(60) Provisional application No. 60/312,260, filed on Aug. 14, 2001.

(51) Int. Cl. G06F 19/00

(52) U.S. Cl. 702/81

(57) ABSTRACT

A system and method for performing machine vision inspection of display devices or display-based products, such as LCD-based products. A user may first interact with a display inspection test configurator to create or specify a display inspection algorithm or script comprising a plurality of display inspection functions. A test executive sequence that implements the display inspection algorithm may then be automatically, i.e., programmatically generated. The test executive sequence may then be executed to perform machine vision tests of one or more display devices.

### PRIORITY CLAIM

This application claims benefit of priority of U.S. provisional application Serial No. 60/312,260 titled “System and Method for Creating a Test Executive Sequence to Perform LCD Display Inspection” filed Aug. 14, 2001, whose inventors are Dinesh Nair, Kevin L. Schultz and Joseph Pearson.

### FIELD OF THE INVENTION

The present invention relates to the fields of image processing software for analyzing images and test executive software for organizing and executing test executive sequences. In particular, the invention relates to a system and method for creating a test executive sequence to inspect LCD display devices.

### DESCRIPTION OF THE RELATED ART

The development of the liquid crystal display (LCD) has enabled the creation of whole product categories that otherwise would not have been possible. For example, the heavy CRT-based “portable” computer has given way to the modern slim notebook computer that can fit in a small shoulder bag. As another example, fixed conference room projection display systems are giving way to the bright, ultra-portable projectors that allow presentations to be given anywhere.

Today, the development of new technologies has created new opportunities for the LCD. For example, just as the LCD has allowed portable computer and business projector products to flourish, the evolution of cellular technologies and the Internet have opened up wide possibilities for new products dedicated to connecting people to the outside world through mobile terminal, portable, desktop, and automobile LCD-based devices. As a result of this connection evolution, new LCD technologies, such as color and higher resolution LCD's, are being introduced within the cell phone and personal digital assistant (PDA) or mobile terminal sectors.

Commonly known as 2nd and 3rd Generations, the introduction of the Internet and color and higher resolution displays, along with the merging between cell phone and PDA functions, is resulting in a new category within the mobile terminal product sector, referred to as the hybrid mobile terminal. For example, these hybrid mobile terminals will be required to support Internet and downloadable applications as they become available through service providers. The growth projections for this type of product are from 10 million units in 2000 to over 400 million in 2006.

Nearly fifty LCD-based product sectors have evolved over time. LCD-based product sectors include: LCD flat panel monitors, flat panel TV's, portable computers, automobile displays, cellular phones, PDA's, and medical devices, among others. According to a Stanford Resource study, a 37% growth in all LCD manufacturing is projected between 2000 and 2006. In 2000, there were 2.2 billion displays manufactured, and these displays were further integrated into end products. Thus, by 2006, this number is expected to increase to approximately 3 billion. The market size of mobile terminals alone is expected to grow from about 400 million in 2000 to above 800 million in 2006.

Thus, the manufacture of LCD-based products constitutes a significant portion of U.S. and worldwide economic activity. It would therefore be desirable to make the manufacturing processes for LCD-based products as efficient as possible.

One aspect of manufacturing an LCD device or LCD-based product involves quality control. Machine vision inspection is often used to detect defects in an LCD device by acquiring images of the device and using various types of image processing algorithms to analyze the images. Image processing software operable to perform any of various types of image analysis or image processing functions or algorithms may be used to examine acquired images of the device. For example, the images may be analyzed to determine information such as pattern and color information, and this information may be used to verify that the LCD surface is not scratched or otherwise defective, that the LCD device includes all necessary components in the correct locations, that the LCD device has the appropriate labels or markings, etc.

However, prior art systems for performing machine vision inspection of LCD devices and LCD-based products have not been sufficiently flexible, powerful, or efficient. By providing an improved machine vision inspection system for LCD devices and LCD-based products, the manufacturing processes for this important class of products could be improved significantly.

LCD and terminal manufacturers require a more complete system than the traditional tools-based approach. The manufacturers need a system that will enable them to go quickly to market with new display devices without needing to become machine vision software experts themselves. They need a ready-to-use system that is also scalable. They need a system that can easily be configured to perform some of the basics display tests without writing code.

The manufacturers would also like to be able to add their own specialized tests by writing code at a later time. For example, some terminal and display manufacturers and OEMs would like to perform other tests on their device in addition to machine vision tests, such as audio tests, shock tests, and noise-vibration-harshness (NVH) tests. One way to achieve this desired power and flexibility would be to integrate the display inspection software with test executive software.

Test executive software is specialized software that allows a user to organize and execute sequences of reusable test modules to test units under test (UUTs), e.g., LCD devices or LCD-based products. For example, the test modules may interact with one or more hardware instruments to test the UUT(s). The test modules often have a standard interface and typically can be created in a variety of programming environments. The test executive software operates as a control center for the automated test system. More specifically, the test executive software allows the creation, configuration, and/or control of test sequence execution for various test applications, such as production and manufacturing test applications. Text executive software typically includes various features, such as test sequencing based on pass/fail results, logging of test results, and report generation, among others.

Test executives include various general concepts. The following comprises a glossary of test executive nomenclature, as used herein:

Code Module—A program module, such as a Windows Dynamic Link Library (.dll), LabVIEW VI (.vi), ActiveX component, or other type of program module or component, that implements one or more functions that perform a specific test or other action.

Test Module—A code module that performs a test of a UUT.

Step—An action that can be included within a sequence of other actions. A step may call a test module to perform a specific test.

Step Module—The code module that a step calls.

Sequence—A series of steps specified for execution in a particular order. Whether and when a step is executed can depend on the results of previous steps.

Sequence File—A file that contains the definition of one or more sequences.

Sequence Editor—A program that provides a graphical user interface for creating, editing, and debugging sequences.

Run-time Operator Interface—A program that provides a graphical user interface for executing sequences on a production station. A sequence editor and run-time operator interface can be separate application programs or different aspects of the same program.

Test Executive Engine—A module or set of modules that provide an API for creating, editing, executing, and debugging sequences. A sequence editor or run-time execution operator interface uses the services of a test executive engine.

Application Development Environment (ADE)—A programming environment such as LabVIEW, LabWindows/CVI, Microsoft Visual C++, Microsoft Visual Basic, etc., in which the user can create test modules and run-time operator interfaces.

Unit Under Test (UUT)—The device or component that is being tested.

Thus, a test executive sequence comprising a plurality of steps may be constructed, and this sequence may then execute under control of the test executive engine to perform tests of a UUT, e.g., an LCD device or LCD-based product.

### SUMMARY OF THE INVENTION

One embodiment of the present invention comprises a system and method for performing automated inspection of display devices or display-based products. The display devices may comprise any of various types of display devices, e.g., LCD devices or LCD-based products, such as flat panel monitors, flat panel TV's, portable computers, automobile displays, cellular phones, PDA's, or medical devices, among others.

According to one embodiment of the method, a user may first interact with a display inspection test configurator to create or specify a display inspection algorithm or script. The display inspection test configurator may provide a graphical user interface enabling a user to create or specify the desired display inspection algorithm in an intuitive, easy-to-use manner. The display inspection algorithm may comprise a plurality of display inspection functions. For example, user input specifying the desired display inspection functions and the desired order of the functions may be received. In various embodiments, the display inspection algorithm or script may be specified in any of various ways. For example, the user may select the desired functions by dragging and dropping icons representing the functions from a palette, by utilizing menu options, or in any of various other ways.

In various embodiments, the display inspection test configurator may provide access to display inspection functions operable to perform any of various types of inspections or tests of a display device. In one embodiment, the display inspection test configurator may provide access to a plurality of machine vision-related display inspection functions. For example, images of the display devices may be acquired by one or more cameras, and these images may then be analyzed by one or more display inspection functions. The results of the image analysis may be used to determine whether a display device meets desired production standards.

In various embodiments, the machine vision-related display inspection functions may be operable to analyze the images of the display devices in any of various ways, e.g., for any of various characteristics or defects, using any of various image processing techniques. As a few examples, the display devices may be analyzed for alignment of an LCD within a housing, for dust or scratches on the display, for pixel defects in the display, for background illumination levels, for verification of displayed characters, for contrast levels, for the presence or absence of logos and icons, for color or other characteristics of display housing, etc. These types of analyses may be implemented using any desired image processing or image analysis techniques, such as edge detection, pattern matching, color matching, optical character recognition, BLOB analysis, etc.

In other embodiments, the display inspection test configurator may provide access to display inspection functions operable to perform other types of inspections or tests of a display device, in addition to or instead of machine-vision related tests. For example, display inspection functions may be related to audio tests (e.g., to test function or quality of an audio component of the display device), shock tests or noise-vibration-harshness (NVH) tests, mechanical tests (e.g., to test function or quality of a mechanical component of the display device), battery tests (e.g., to test function or quality of a battery of the display device), and/or current draw or other electrical tests (e.g., to test current draw or other electrical characteristics or RF parameters of the display device), among other types of tests.

Once the display inspection algorithm has been created, a test executive sequence that implements the display inspection algorithm may then be automatically, i.e., programmatically generated. In one embodiment, the test executive sequence may be programmatically generated with no user input. In another embodiment, a small amount of user input may be prompted for, e.g., to ask for a name of a sequence file in which to persistently store the generated test executive sequence, etc.

The test executive sequence may be generated so as to have a plurality of test executive sequence steps. For example, for each display inspection function specified in the display inspection algorithm, the test executive sequence may include a corresponding test executive step for display inspection. In one embodiment, the test executive steps for display inspection may be configured to call the respective display inspection functions as external code modules when executed.

In one embodiment, the test executive sequence may be generated with other steps in addition to the display inspection steps. For example, the test executive sequence may include one or more initial steps to initialize a camera used to acquire the images of the display devices, to initialize the display inspection functions, etc.

The test executive sequence may then be executed to perform machine vision tests, and/or possibly other types of tests, of one or more display devices. The test executive sequence may execute under control of test executive software. The test executive sequence software may provide features such as result collection, report generation, etc. The test executive sequence software may be executed in a machine vision inspection system to repetitively test a plurality of displays. The test executive sequence software may provide a simple graphical mechanism to integrate and operate a plurality of measurement or inspection devices and functions together in the machine vision inspection system.

Each display inspection function may have its own specialized graphical user interface, e.g., a dialog or wizard, for configuring that function. The user may customize the operation of the display inspection functions graphically, by setting various parameters or properties, without having to write any program code. In one embodiment, the graphical user interfaces of the functions may be accessed from the display inspection test configurator. In another embodiment, the graphical user interfaces may be accessed from within the test executive. For example, after the test executive sequence has been generated, the test executive sequence may be opened from within a sequence editor of the test executive, and the sequence editor may be operable to invoke the graphical user interfaces. Thus, the operation of each display inspection step may be customized after the sequence has been generated.

### BRIEF DESCRIPTION OF THE DRAWINGS

A better understanding of the present invention can be obtained when the following detailed description of the preferred embodiment is considered in conjunction with the following drawings, in which:

FIG. 1 is a diagram illustrating one embodiment of a machine vision inspection system for inspecting display devices;

FIG. 2 is a block diagram of the computer system shown in FIG. 1;

FIG. 3 is a block diagram illustrating a software architecture for one embodiment of the invention;

FIG. 4 illustrates an exemplary library of display inspection functions;

FIG. 5 illustrates a test executive application software architecture according to one embodiment of the present invention;

FIG. 6 is a flowchart diagram illustrating one embodiment of a method for performing inspection of a display device or display-based product, e.g., an LCD-based product; and

FIGS. 7-11 illustrate exemplary screen shots for various software elements described herein.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Incorporation by Reference

The following references are hereby incorporated by reference in their entirety as though fully and completely set forth herein.

U.S. patent application Ser. No. 09/259,162 titled “Test Executive System and Method Including Step Types for Improved Configurability,” filed Feb. 26, 1999.

U.S. patent application Ser. No. 09/587,682 titled “System and Method for Automatically Generating a Graphical Program to Perform an Image Processing Algorithm,” filed Jun. 5, 2000.

U.S. Provisional Patent Application No. 60/301,799 titled “System and Method for Specifying a Machine Vision Process Using Different Programming Methodologies,” filed Jun. 29, 2001.

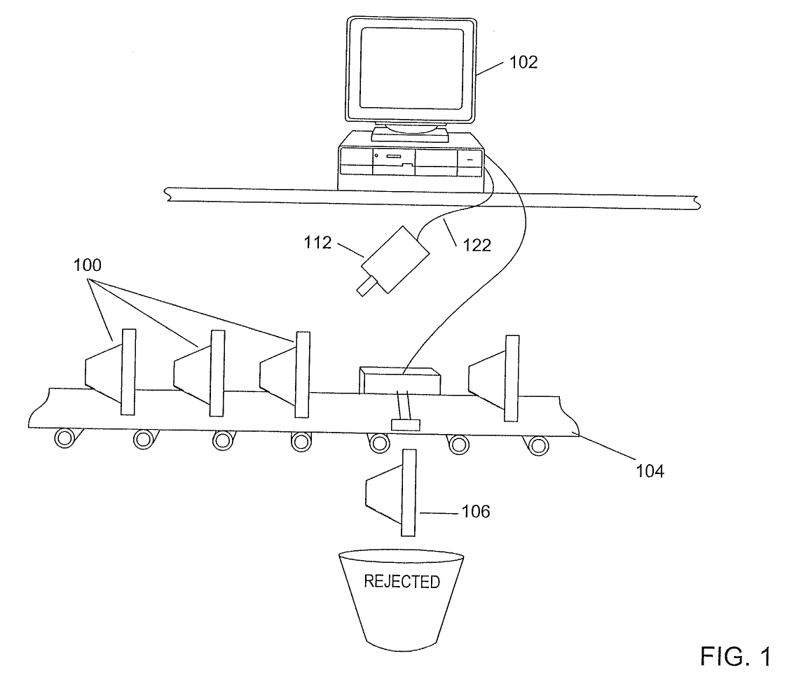

FIG. 1—Machine Vision Inspection System

FIG. 1 is a diagram illustrating one embodiment of a machine vision inspection system (also referred to as an image acquisition and analysis system) for inspecting display devices 100. The display devices may comprise any of various types of display devices, e.g., LCD devices or LCD-based products, such as flat panel monitors, flat panel TV's, portable computers, automobile displays, cellular phones, PDA's, or medical devices, among others.

The system of FIG. 1 illustrates a plurality of display devices 100 that move along a manufacturing apparatus 104. The display devices 100 may have any of various types of shapes and sizes. The system includes one or more cameras 112 operable to acquire images of the display devices 100 as they move along the manufacturing apparatus 104. In another embodiment, the display devices may not move along a manufacturing apparatus 104. For example, the system may be utilized to acquire and analyze images of a single display device 100, or the display devices 100 may be placed in front of the camera 112 in a stationary manner. In various embodiments, any number of cameras 112 may be used. The camera(s) 112 may comprise any type of camera or device operable to acquire images of the display devices 100.

As shown in FIG. 1, the camera 112 may be connected to a computer system 102, which is operable to receive the images acquired by the camera. In another embodiment, the computer system 102 may receive images acquired from multiple cameras. For example, the computer system 102 may include one or multiple image acquisition boards, each for capturing one or more images. The computer system 102 may then analyze the images captured by the image acquisition board(s). Alternatively, the image acquisition board(s) may include on-board processors and memory for performing a portion or all of the image analysis.

In one embodiment, the computer system 102, or another computer system, may be operable to provide a signal to each display device 100 to cause each display device to display a test pattern, e.g., by turning on or off certain pixels on the display device. The computer system 102, or another system, may then acquire an image of the test pattern for analysis. The computer system 102, or another system, may also be operable to provide a plurality of different test pattern signals to each display device to cause each display device to present the plurality of different test patterns. The computer system 102 may then acquire an image of each test pattern for analysis.

In various embodiments, the images of the display devices 100 may be analyzed in any of various ways, e.g., may be analyzed for any of various defects, using any of various image processing techniques. As a few examples, the display devices may be analyzed for alignment of an LCD within a housing, for dust or scratches on the display, for pixel defects in the display, for background illumination levels, for verification of displayed characters, for contrast levels, for the presence or absence of logos and icons, for color or other characteristics of display housing, etc. These types of analyses may be implemented using any desired image processing or image analysis techniques, such as edge detection, pattern matching, color matching, optical character recognition, BLOB analysis, etc.

The results of the image analyses may be used to determine whether a display device 100 meets desired production standards. The determination may be made based on any of various criteria, as desired for a particular application. If separate computer systems are used to analyze the images, the results from each computer system may be considered together in making this determination. If a display device does not meet the desired production standards, the display device may be rejected. For example, in rejecting the display device, the display device may be removed from the manufacturing apparatus 104, as indicated in FIG. 1 by the rejected display device 106, or the system may store information indicating that the display device failed the inspection. Also, images of the rejected display device may be stored if desired.

The computer system 102 may be a computer system of any type. In one embodiment, multiple computer systems 102 may be employed, e.g., to distribute the image processing load across multiple computer systems. In one embodiment, the computer system(s) 102 may comprise a controller or card (a “computer on a card”) housed in a PXI, VXI or other type of chassis. The chassis may further include one or more image acquisition boards which couple to one or more cameras 112.

The computer system(s) 102 preferably include a memory medium on which software according to one embodiment of the invention is stored. This software may be operable to receive and analyze the images of the display devices 100. In one embodiment, the computer system(s) 102 may execute a test executive sequence that executes under control of test executive software. The test executive sequence may implement a display inspection algorithm to test for various display defects, such as those described above. As described below, a user may have first specified the display inspection algorithm using an easy-to-use display inspection test configurator interface. The test executive sequence may have then been automatically, i.e., programmatically, generated from the specified display inspection algorithm. One embodiment of a method for programmatically generating a test executive sequence operable to implement a display inspection algorithm is described below.

In one embodiment, the memory medium may store the test executive sequence, as well as the test executive software which is operable to manage execution of the sequence. In one embodiment, the memory medium may also store an application that provides the display inspection test configurator interface used to specify the desired display inspection algorithm. Also, the memory medium may store a library of display inspection functions operable to perform the actual image processing of the acquired images. For example, as described above, steps in the test executive sequence may call various external code modules. The library of display inspection functions may implement these external code modules. Thus, each display inspection step in a test executive sequence may map to or call a function from the library of display inspection functions. It is noted that in various embodiments, the analysis of the images of the display devices 100 may be performed in any of various manners, either in software, programmable logic, or hardware, or a combination thereof.

The term “memory medium” is intended to include an installation medium, e.g., a CD-ROM, floppy disks 104, or tape device, a computer system memory or random access memory such as DRAM, SRAM, EDO RAM, Rambus RAM, etc., or a non-volatile memory such as a magnetic media, e.g., a hard drive, or optical storage. The memory medium may comprise other types of memory as well, or combinations thereof.

In addition, the memory medium may be located in a first computer in which the programs are executed, or may be located in a second different computer which connects to the first computer over a network, such as the Internet. In the latter instance, the second computer provides the program instructions to the first computer for execution. Also, the computer system(s) 102 may take various forms, including a personal computer system, PXI or VXI card, mainframe computer system, workstation, network appliance, or other device. In general, the term “computer system” can be broadly defined to encompass any device having at least one processor which executes instructions from a memory medium.

Although FIG. 1 illustrates a machine vision inspection system and machine vision-related tests are discussed above, it is noted that in various embodiments the display inspection algorithm may include display inspection functions operable to perform other types of tests of a display device, including audio tests (e.g., to test function or quality of an audio component of the display device), shock tests or noise-vibration-harshness (NVH) tests, mechanical tests (e.g., to test function or quality of a mechanical component of the display device), battery tests (e.g., to test function or quality of a battery of the display device), and/or current draw or other electrical tests (e.g., to test current draw or other electrical characteristics or RF parameters of the display device), among other types of tests. Thus, in addition to steps operable to perform machine vision-related tests, the test executive sequence may also (or may instead) include steps operable to perform other types of tests of a display device.

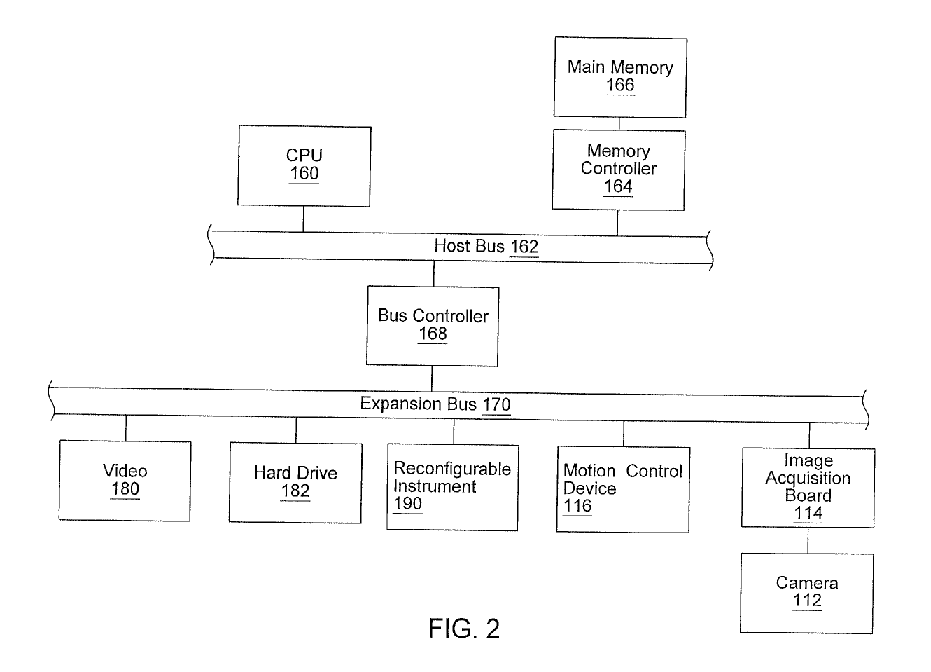

FIG. 2—Computer System Block Diagram

FIG. 2 is a block diagram of the computer system 102 illustrated in FIG. 1. It is noted that any type of computer system configuration or architecture can be used as desired, and FIG. 2 illustrates a representative PC embodiment. It is also noted that the computer system may be a general purpose computer system as shown in FIG. 1, a computer implemented on a VXI card installed in a VXI chassis, a computer implemented on a PXI card installed in a PXI chassis, or other types of embodiments. Elements of a computer not necessary to understand the present invention have been omitted for simplicity.

The computer 102 includes at least one central processing unit or CPU 160 that is coupled to a processor or host bus 162. The CPU 160 may be any of various types, including an x86 processor, e.g., a Pentium class, a PowerPC processor, a CPU from the SPARC family of RISC processors, as well as others. Main memory 166 is coupled to the host bus 162 by means of memory controller 164.

The main memory 166 may store software according to one embodiment of the present invention, such as described above with reference to FIG. 1. The main memory 166 may also store operating system software as well as other software for operation of the computer system, as well known to those skilled in the art.

The host bus 162 is coupled to an expansion or input/output bus 170 by means of a bus controller 168 or bus bridge logic. The expansion bus 170 is preferably the PCI (Peripheral Component Interconnect) expansion bus, although other bus types can be used. The expansion bus 170 may include slots for various devices such as an image acquisition board 114 and a motion control device board 116. A camera device 112 may be connected to the image acquisition board 114. The computer 102 further comprises a video display subsystem 180 and hard drive 182 coupled to the expansion bus 170.

As shown, a reconfigurable instrument 190 may also be connected to the computer 102. The reconfigurable instrument 190 may include a functional unit, also referred to as configurable logic, such as a programmable logic device (PLD), e.g., an FPGA, or a processor and memory, which may execute a real time operating system. Program instructions may be downloaded and executed on the reconfigurable instrument 190. In one embodiment, at least a portion of the software described herein, e.g., a portion of the test executive software and/or a portion of the library of display inspection functions, may execute on the reconfigurable instrument 190. In various embodiments, the functional unit may be comprised on an instrument or device connected to the computer through means other than an expansion slot, e.g., the instrument or device may be connected via an IEEE 1394 bus, USB, or other type of port. Also, the functional unit may be comprised on a device such as a data acquisition board.

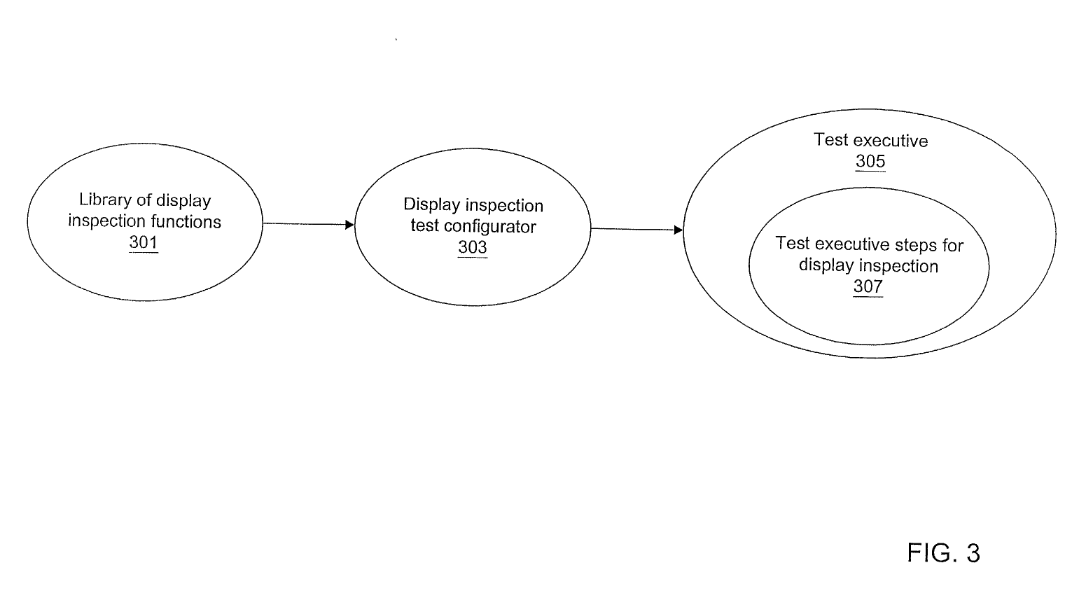

FIG. 3—Software Architecture

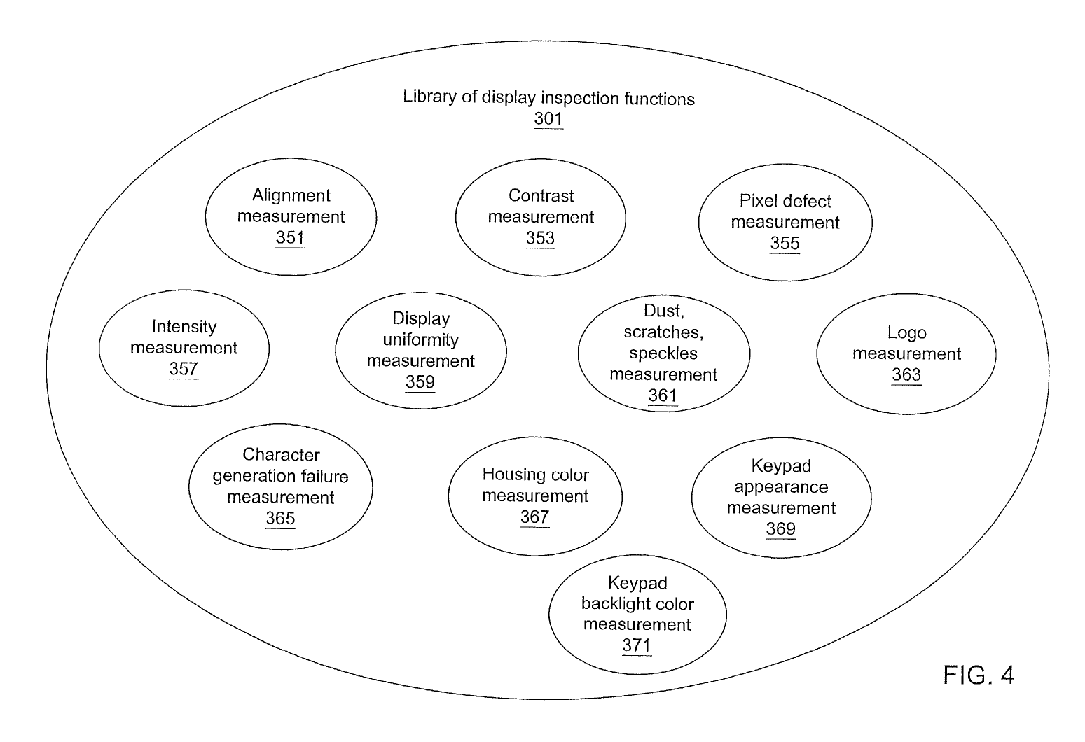

FIG. 3 is a block diagram illustrating a software architecture for one embodiment of the invention. As shown, a library of display inspection functions 301 may be provided. The library of display inspection functions 301 may include functions for inspecting a display device in any of various ways. For example, the functions may include machine vision-related functions operable to analyze an acquired image of the display device to determine various characteristics, as well as other types of functions. Exemplary display inspection functions are discussed below with reference to FIG. 4.

The library of display inspection functions 301 may be implemented using any of various programming tools or techniques. For example, the display inspection functions may be constructed according to object-oriented and/or procedural programming techniques. In one embodiment, the display inspection functions may be constructed using graphical programming techniques, e.g., may be constructed using a graphical programming development environment, such as LabVIEW, Simulink, VEE, etc. In one embodiment, the display inspection functions may be constructed or packaged according to a software component specification. For example, the functions may be packaged as COM or ActiveX objects, CORBA objects, JavaBeans or other Java objects, etc. The display inspection functions may be written using any desired programming language, such as C, C++, Java, Visual Basic, Pascal, etc., and may be written using any desired programming tools or application development environments, such as Microsoft Visual Studio, LabVIEW, LabWindows/CVI, etc.

As shown in FIG. 3, a display inspection test configurator 303 may interface with or utilize the library of display inspection functions. The display inspection test configurator 303 may provide a graphical user interface enabling a user to create or specify a desired display inspection algorithm or script in an intuitive, easy-to-use manner. For example, in one embodiment, the user may select the desired functions and place the functions in the desired order to assemble the display inspection algorithm. For example, the user may select the desired functions by dragging and dropping icons representing the functions from a palette, by utilizing menu options, or in any of various other ways.

Each display inspection function may have its own specialized graphical user interface for configuring that function. For example, this graphical user interface may be implemented as a dialog box or wizard. The graphical user interface for a display inspection function may enable the user to customize the operation of the function graphically, by setting various parameters or properties, without having to write any program code. For example, for a “contrast measurement” machine vision function, the graphical user interface may include fields enabling the user to set minimum and maximum limits within which the measured contrast level must fall in order for the display device to pass the contrast measurement test. For each display inspection function included in the display inspection algorithm, the user may invoke the function's graphical user interface if desired, to customize the operation of the function.

Once the desired display inspection algorithm has been specified, a test executive sequence to implement the algorithm may be generated. In the preferred embodiment, the test executive sequence may be automatically, i.e., programmatically, generated from the display inspection algorithm specified in the display inspection test configurator. For example, after creating the desired algorithm, the user may select a “Generate Test Executive Sequence” menu item. In another embodiment, the test executive sequence may be created and updated automatically as the user creates the display inspection algorithm, and the user may not need to explicitly request generation of the test executive sequence.

As shown in FIG. 3, the architecture includes a test executive 305. The generated test executive sequence may execute under control of the test executive 305. In various embodiments, the test executive 305 may comprise any of various test executive applications, such as TestStand from National Instruments. The architecture also includes a set of test executive steps for display inspection, available for inclusion in a test executive sequence.

Thus, the test executive sequence may be programmatically generated so as to include a plurality of test executive steps for display inspection. For example, each test executive step for display inspection may correspond to a display inspection function in the specified display inspection algorithm. In one embodiment, each test executive step for display inspection 307 may call the corresponding display inspection function as an external code module. Thus, the test executive may provide various capabilities useful for testing a display device, such as result collection, report generation, etc., but the actual work of analyzing the images of the display device or performing other tests of the display device may be performed by the library of display inspection functions 301.

In various embodiments, the elements of FIG. 3 may interface in any of various ways. These elements may be included in a single application or may be implemented in different applications operable to interface with one another. For example, in one embodiment, the display inspection test configurator 303 may be launched as a separate window from the test executive 305, while in another embodiment, the configurator 303 may be invoked from the desktop as a separate application. In one embodiment, the display inspection algorithm may be created using the display inspection test configurator 303 and may be persistently stored, and the test executive sequence may be generated from the stored algorithm at a later time. Also, in one embodiment, the configurator 303 may be operable to execute the display inspection algorithm itself, but may not be able to provide all the flexibility and execution features that would be available if the algorithm were executed from the environment of the test executive 305.

The test executive sequence software may be executed in a machine vision inspection system to repetitively test a plurality of displays. The test executive sequence software may provide a simple graphical mechanism to integrate and operate a plurality of measurement or inspection devices and functions together in the machine vision inspection system.

FIG. 4—Library of Display Inspection Functions

In various embodiments, the library of display inspection functions 301 may include any of various types of display inspection functions. FIG. 4 illustrates a set of exemplary machine vision-related functions that may be included in this library. Some of these functions are related to the display portion itself of the device, while others are for testing various other aspects of products or devices that include a display, such as housings, keypads, etc. It is noted that in other embodiments, any of various other functions for measuring or testing any of various other aspects of display devices or display-based products may be included. For example, where it is desired to perform tests of a cellular phone, the library of display inspection functions may include cellular phone-specific functions, e.g., to check the antennae, etc.

An alignment measurement function 351 may measure the position of the display screen within the housing of the product.

A contrast measurement function 353 may determine the contrast (difference between bright and dark pixel values) in an image displayed on the display device.

A pixel defect measurement function 355 may determine whether all the pixels of the display screen turn ON and OFF correctly.

An intensity measurement function 357 may determine the mean intensity of the pixels in an image displayed on the display device.

A display uniformity measurement function 359 may calculate the mean and variance of an image of constant intensity displayed on the display device.

A dust/scratches/speckles measurement function 361 may check for cosmetic defects on the display.

A logo measurement function 363 may determine whether predefined logos appear correctly on the display screen. These logos can be hard-coded on the screen or generated through controlling pixel intensities.

A character generation failure measurement function 365 may determine whether characters to be displayed on the display screen appear correctly.

A housing color measurement function 367 may determine whether the color of the device housing meets specifications, e.g., may look for discoloration on the housing.

A keypad appearance measurement function 369 may determine whether all the keys are present at the right locations on a keypad of the device (e.g., for a cell phone) and may determine whether the print/color quality of the keys meet some predefined standards.

A keypad backlight color measurement function 371 may determine whether keys on a keypad of the device are backlit correctly.

Test Executive Software Components

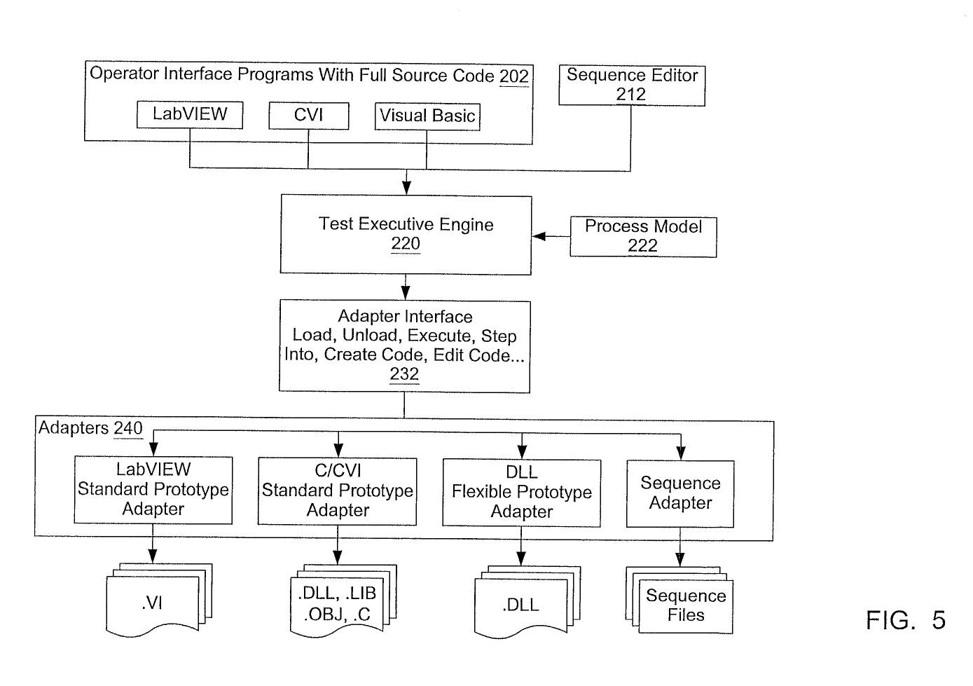

FIG. 5 is a block diagram illustrating high-level architectural relationships between elements of one embodiment of a test executive software application. It is noted that FIG. 5 is exemplary, and the present invention may be utilized in conjunction with any of various test executive software applications. In one embodiment, the elements of FIG. 5 are comprised in the TestStand test executive product from National Instruments. As shown, the test executive software of FIG. 5 includes operator interface programs 202 for interfacing to various software programs. The operator interface programs 202 shown in FIG. 5 are for interfacing to the LabVIEW, LabWindows/CVI, and Visual Basic programs. However, additional operator interface programs 202 may be included for interfacing to other programs.

The test executive software of FIG. 5 also includes a sequence editor 212 for interactively creating and editing test executive sequences. The sequence editor 212 and the operator interface programs 202 interface to the test executive engine 220. One or more process models 222 couple to the test executive engine 220. The test executive engine 220 interfaces through an adapter interface 232 to one or more adapters 240. The adapters shown in FIG. 5 include the LabVIEW standard prototype adapter, the C/CVI prototype adapter, the DLL flexible prototype adapter, and the sequence adapter. The LabVIEW standard prototype adapter interfaces to program modules having a .VI extension, i.e., LabVIEW graphical programs. The C/CVI prototype adapter interfaces to program modules having a .dll, lib, .obj, or .c extension. The DLL flexible prototype adapter interfaces to program modules having a .dll extension. The sequence adapter interfaces to sequence files.

The test executive engine 220 manages the execution of test executive sequences. Sequences comprise steps that may call external code modules. By using module adapters 240 that have the standard adapter interface 232, the test executive engine 220 can load and execute different types of code modules. Thus, the test executive may be independent from particular application development environments (ADEs) used to create the code modules. In one embodiment, the test executive may use a special type of sequence called a process model to direct the high-level sequence flow. The test executive engine 220 may implement an API used by the sequence editor 212 and runtime operator interfaces 202.

Test Executive Sequence Editor

The sequence editor 212 may be an application program in which the user creates, modifies, and/or debugs test executive sequences. The sequence editor 212 may have a graphical user interface (GUI) enabling a user to efficiently create a test executive sequence for testing a system or unit under test. For example, the sequence editor 212 may provide the user with easy access to test executive features, such as step types, step properties, sequence parameters, step result collection, etc.

In one embodiment, the sequence editor 212 may also include an execution window that provides debugging tools, such as those found in application development environments such as LabVIEW, LabWindows/CVI, Microsoft Visual C/C++, Microsoft Visual Basic, etc. These may include features such as breakpoints, single stepping, tracing, a variable display, a watch window, etc.

In one embodiment, in the sequence editor 212, the user may start multiple concurrent executions. Multiple instances of the same sequence can be executed, and different sequences can be executed at the same time, e.g., as separate threads in a multi-threaded system. Each execution instance may have its own execution window. In trace mode, the execution window may display the steps in the currently executing sequence. When execution is suspended, the execution window may display the next step to execute and provide single-stepping options.

As described above, according to one embodiment of the invention, a test executive sequence to implement a display inspection algorithm may be programmatically generated from an algorithm developed in the display inspection test configurator, e.g., may be generated independently of user input. Thus, the sequence editor 212 may not initially be used to create the test executive sequence. However, the user may then use the sequence editor 212 to modify the generated test executive sequence, if desired. For example, the user may add additional steps to the test executive sequence, e.g., to perform other types of tests on the display device in addition to machine vision-based tests, such as audio tests, shock tests, noise-vibration-harshness (NVH) tests, etc.

Test Executive Engine

The test executive engine 220 may be used when creating, editing, executing, and debugging test executive sequences. The test executive engine 220 may also provide a test executive engine application programming interface (API) that enables another program to interface with the test executive engine 220 in order to perform these actions. In one embodiment, a test executive sequence based on a display inspection algorithm may be programmatically generated by calling the API of the test executive engine.

In one embodiment, the test executive engine 220 may export an object-based or component-based API, which in one embodiment may be an ActiveX Automation API. The sequence editor 212 and run-time operator interfaces 202 may use the test executive engine API. The engine API may be called from any programming environment able to use the API. For example, where the API comprises an ActiveX Automation API, the engine API may be called from any programming environment that supports access to ActiveX Automation servers. Thus, in various embodiments, the engine API may be called from test modules written in various programming environments, including test modules that are written in LabVIEW, LabWindows/CVI, Microsoft Visual C++, Microsoft Visual Basic, Java, etc.

One task performed by the test executive engine 220 is to manage the execution of test executive sequences. Executing a sequence may comprise executing steps included in the sequence. Not all steps in the sequence are necessarily executed. For example, the user may configure some steps to be skipped, e.g., depending on execution results of previous steps. For a step that references a user-supplied code module, executing the step may comprise executing the respective code module.

In addition to these user-supplied code modules being executed, for each step, additional program instructions may be executed, wherein these additional program instructions implement additional functionality specified for the step. These additional program instructions may be specified by the test executive software, rather than being defined by the respective user-supplied code module for the step. As one example, when including a step in a sequence, the user may configure execution results of the step to be collected. In this example, when the step is executed, program instructions to store the step results accordingly may be executed in addition to the program instructions of a user-supplied code module that the step references.

It is noted that not all steps may reference a user-supplied code module. For example, the test executive may provide some step types that primarily affect various aspects of sequence execution and are not designed to reference user-supplied code modules.

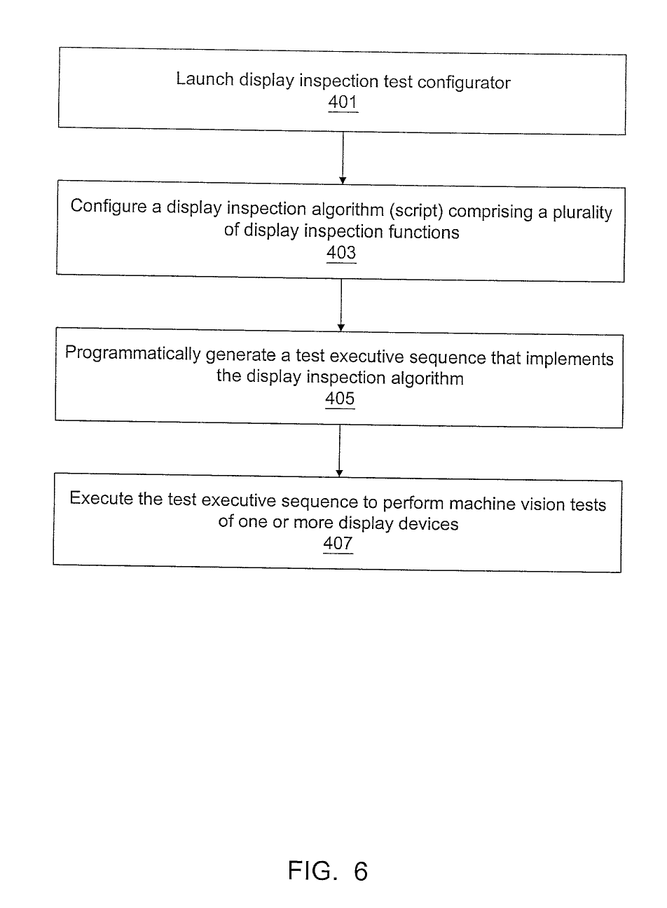

FIG. 6—Inspection of a Display Device

FIG. 6 is a flowchart diagram illustrating one embodiment of a method for performing inspection of a display device or display-based product, e.g., an LCD-based product.

In step 401, the display inspection test configurator 303 may be launched. As described above, the display inspection test configurator may provide a graphical user interface enabling a user to create or specify a desired display inspection algorithm or script in an intuitive, easy-to-use manner.

In step 403, a display inspection algorithm or script comprising a plurality of display inspection functions may be configured. For example, user input specifying the desired display inspection functions and the desired order of the functions may be received. In various embodiments, the display inspection algorithm or script may be specified in any of various ways, e.g., depending on the means provided for by the graphical user interface of the display inspection test configurator. For example, the user may select the desired display inspection functions by dragging and dropping icons representing the functions from a palette, by utilizing menu options or keyboard commands, or in any of various other ways. As the image processing algorithm is configured, functions or operations in the algorithm may be indicated to the user in any of various ways. For example, a list of functions or operations in the algorithm may be displayed, e.g., textually or iconically.

In one embodiment, each display inspection function may have its own specialized graphical user interface, e.g., a dialog or wizard, for configuring that function. The user may invoke the graphical user interfaces for the display inspection functions to customize their operation, e.g., to specify parameter values used by the functions, to specify a region of interest on which to operate in an image, etc.

In one embodiment, the user may specify a test image on which to operate while configuring the display inspection algorithm. For example, the user may select an existing image to display from an image file, wherein the existing image approximates what an actual acquired image of a display device is expected to look like during the testing process. As another example, images may be acquired from one or more camera sources or image acquisition devices, e.g., the camera(s) or device(s) may acquire an image of a display device on which the algorithm is intended to operate. As the user adds various machine vision-related display inspection functions to the display inspection algorithm and/or modifies the operation of machine vision-related display inspection functions in the algorithm, the functions in the algorithm may be applied to the selected or acquired image. For some functions, this may involve changing the appearance of the image, e.g., due to filtering operations or other image processing operations applied to the image. Thus, the user may interactively view the results of applying the algorithm to the test image, to understand whether the algorithm produces the desired result.

In step 405, a test executive sequence that implements the display inspection algorithm may be programmatically generated. In one embodiment, the test executive sequence may be programmatically generated by calling an API of the test executive software. In one embodiment, the test executive sequence may be programmatically generated with no user input. In another embodiment, a small amount of user input may be prompted for, e.g., to ask for a name of a sequence file in which to persistently store the generated test executive sequence, etc.

The test executive sequence may be generated so as to have a plurality of test executive sequence steps. For example, for each display inspection function specified in step 403, the test executive sequence may include a corresponding test executive step for display inspection. In one embodiment, the test executive steps for display inspection may be configured to call the respective display inspection functions as external code modules when executed.

In one embodiment, the test executive sequence may be generated with other steps in addition to the display inspection steps. For example, the test executive sequence may include an initial step to initialize the camera used to acquire the images of the display devices.

In step 407, the test executive sequence may be executed to perform machine vision or other tests of one or more display devices, according to the specified display inspection algorithm.

As described above, each display inspection function may have its own specialized graphical user interface for configuring that function, and the user may invoke these graphical user interfaces to configure the functions in the display inspection algorithm, without having to write any program code. In one embodiment, the graphical user interfaces of the functions may be accessed in step 403, e.g., from the display inspection test configurator 303. In another embodiment, the graphical user interfaces may be accessed from within the test executive. For example, after the test executive sequence has been generated, the test executive sequence may be opened from within the sequence editor 212 of the test executive, and the sequence editor 212 may be operable to invoke the graphical user interfaces. Thus, the operation of each display inspection step may be customized after the test executive sequence has been generated.

In one embodiment, the user may add additional steps to the test executive sequence after it has been generated. For example, in a case where the test executive sequence includes only display inspection steps related to machine vision inspection, the user may add additional steps to perform other types of tests on the display device in addition to machine vision-based tests, such as audio tests, shock tests, noise-vibration-harshness (NVH) tests, etc. As noted above, in another embodiment display inspection functions related to these tests may be included in the display inspection algorithm, and it may thus be unnecessary to manually add these steps to the test executive sequence since they may be automatically included when the test executive sequence is generated.

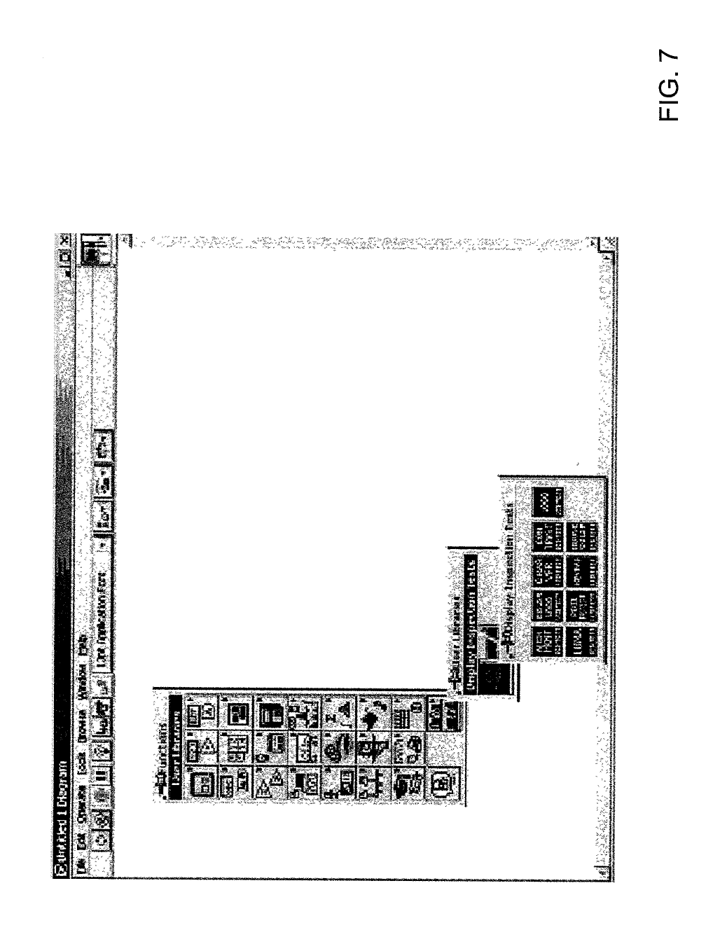

FIGS. 7-10: Exemplary Screen Shots

FIGS. 7-10 illustrate exemplary screen shots for various of the software elements described above.

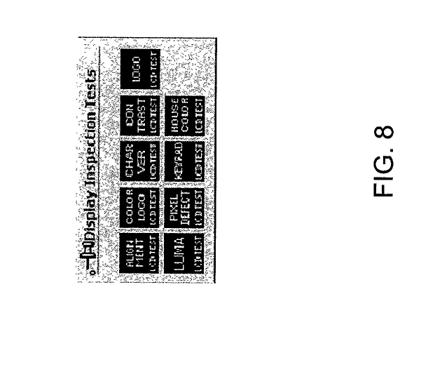

FIGS. 7 and 8 illustrate an exemplary library of display inspection functions. In this case, the display inspection functions are accessible from the LabVIEW graphical programming development environment. For example, the functions may be implemented as LabVIEW virtual instruments (VI's). FIG. 7 illustrates that a display inspection function palette is accessible from LabVIEW, and FIG. 8 illustrates the display inspection function palette in greater detail. It is noted that the functions do not necessarily need to be integrated with an application development environment such as LabVIEW.

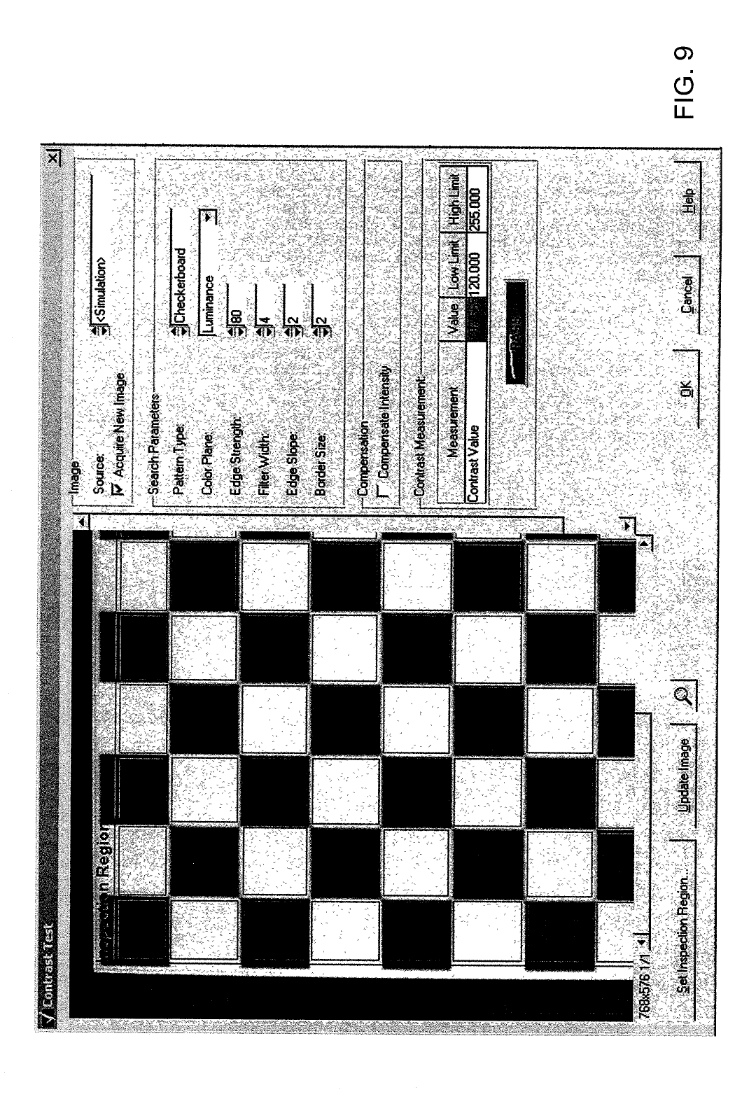

FIG. 9 illustrates a graphical user interface (dialog) for configuring a contrast measurement display inspection function. This dialog may be invokable from the display inspection test configurator when specifying or configuring the display inspection algorithm and/or from within the test executive software after the test executive sequence implementing the algorithm has been generated. The dialog includes fields for customizing operation of the contrast measurement function, such as fields enabling the user to set minimum and maximum limits within which the measured contrast level must fall in order for the display device to pass the contrast measurement test. Thus, the dialog for each display inspection function may be specialized for that particular function, giving the user a high degree of control over the operation of the function, without having to write any code.

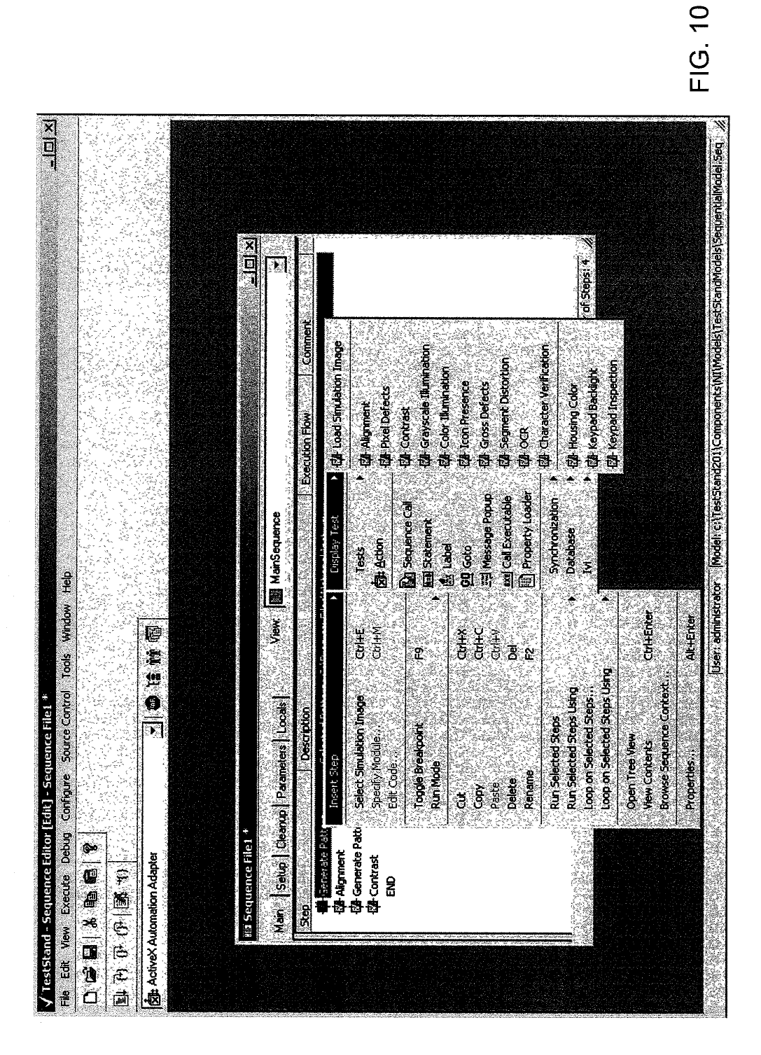

FIG. 10 illustrates a screen shot for an exemplary sequence editor 212 of a test executive application, in which a programmatically generated test executive sequence implementing a display inspection algorithm is open in the sequence editor. The sequence as illustrated includes four steps (shown in the window titled, “Sequence File 1”). The popup menu illustrates a list of possible steps related to testing displays that may be added to the test executive sequence, such as “Load Simulation Image”, “Alignment”, “Pixel Defects”, etc.

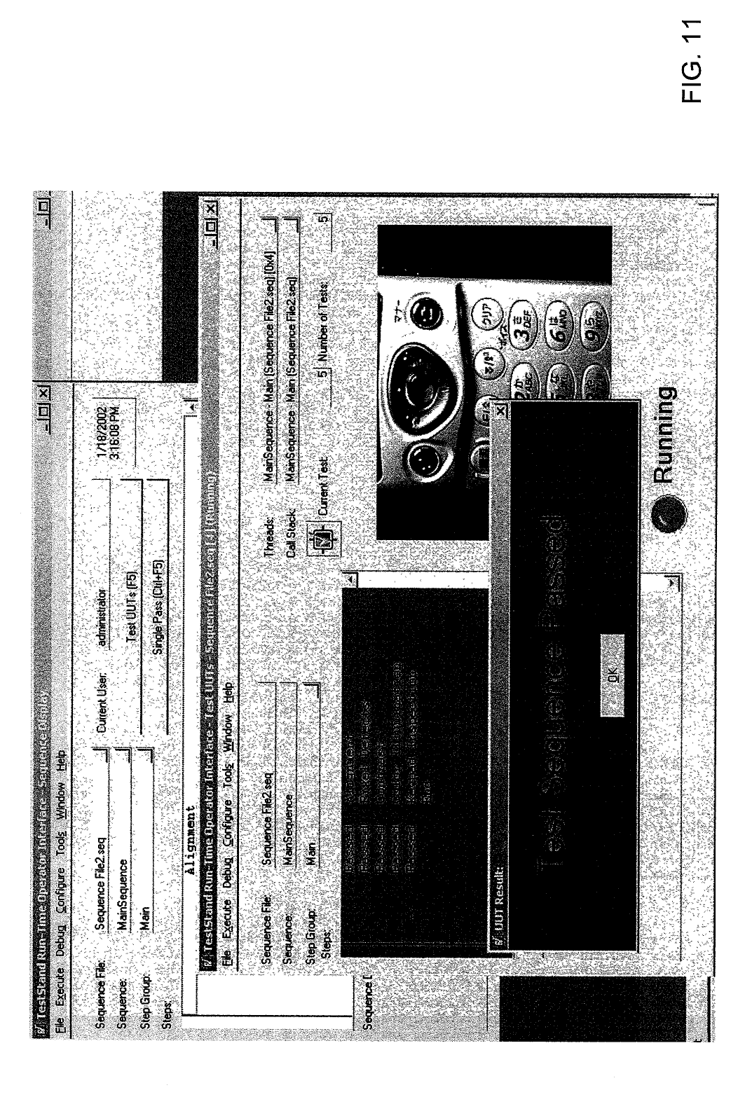

FIG. 11 illustrates a screen shot of an exemplary operator interface for operating a test executive sequence for testing display devices such as described herein. For example, when the sequence is actually deployed on a production floor, the human operator may interact with the operator interface to control the display inspection process. The operator interface in FIG. 11 illustrates the results of executing an exemplary test executive sequence for testing display devices. As shown in FIG. 11, the operator interface may display the current image being inspected. When the sequence is executed, any images that fail inspection may be noted in a results report for the sequence, and the images may also be persistently stored for later access.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for performing machine vision inspection of a display device, the method comprising:
configuring a display inspection algorithm comprising a plurality of display inspection functions operable to perform machine vision tests on the display device;
programmatically generating a test executive sequence that implements the display inspection algorithm; and
executing the test executive sequence to perform the machine vision tests on the display device.

2. The method of claim 1,
wherein said programmatically generating the test executive sequence comprises generating the test executive sequence without receiving user input specifying the test executive sequence.

3. The method of claim 1, further comprising:
displaying a graphical user interface of a display inspection test configurator, wherein the graphical user interface of the display inspection test configurator enables a user to interactively specify the display inspection algorithm; and
receiving user input specifying the display inspection algorithm to the graphical user interface of the display inspection test configurator, wherein the user input specifies the plurality of display inspection functions.

4. The method of claim 1,
wherein said programmatically generating the test executive sequence comprises programmatically including a plurality of test executive steps for display inspection in the test executive sequence.

5. The method of claim 4,
wherein each test executive step for display inspection corresponds to a display inspection function in the display inspection algorithm.

6. The method of claim 4,
wherein each test executive step for display inspection is configured to call one of the display inspection functions as an external code module.

7. The method of claim 4,
wherein the programmatically generated test executive sequence also includes one or more test executive steps to perform initialization of one of:
a hardware device;
the display inspection functions.

8. The method of claim 1, further comprising:
configuring one or more of the display inspection functions in the display inspection algorithm;
wherein, for each display inspection function, configuring the display inspection function comprises:
displaying a specialized graphical user interface for configuring the display inspection function; and
receiving user input to the graphical user interface to customize operation of the display inspection function.

9. The method of claim 8,
wherein the graphical user interface enables the user to specify one or more parameters of the display inspection function.

10. The method of claim 8,
wherein said configuring one or more of the display inspection functions comprises configuring the display inspection functions without specifying program code.

11. The method of claim 1,
wherein said programmatically generating the test executive sequence comprises programmatically including a plurality of test executive steps for display inspection in the test executive sequence;
wherein the method further comprises adding one or more additional test executive steps to the test executive sequence in response to user input.

12. The method of claim 11,
wherein the one or more additional test executive steps include one or more of:
a test executive step to perform a shock test of the display device;
a test executive step to perform a noise-vibration-harshness (NVH) test of the display device;
a test executive step to perform an audio test of the display device;
a test executive step to perform a mechanical test of the display device;
a test executive step to perform a battery test of the display device; and/or
a test executive step to perform an electrical test of the display device.

13. The method of claim 1,
wherein said programmatically generating the test executive sequence comprises programmatically including a plurality of test executive steps for display inspection in the test executive sequence;
wherein said executing the test executive sequence comprises executing the plurality of test executive steps for display inspection to perform the machine vision tests on the display device.

14. The method of claim 13,
wherein said executing the test executive sequence further comprises:
acquiring one or more images of the display device; and
analyzing the one or more images.

15. The method of claim 1,
wherein the display device comprises an LCD device.

16. The method of claim 1,
wherein the display device comprises an OLED device.

17. The method of claim 1,
wherein the display device comprises a flat panel display device.

18. The method of claim 1,
wherein the display device is included as a component in a product.

19. A system for performing display inspection, the system comprising:
a computer system which includes a processor and a memory medium, wherein the memory medium stores:
a library of display inspection functions;
a test configurator which is executable to select a set of display inspection functions in response to user input;
a plurality of test executive steps, wherein each of the plurality of test executive steps is operable to perform display inspection;
an image acquisition device coupled to the computer system, wherein the image acquisition device is operable to acquire an image of a display device being inspected;
wherein the test configurator is useable to programmatically generate a test executive sequence to perform an inspection of a display device, wherein the test executive sequence includes a set of test executive steps operable to invoke at least one of the selected display inspection functions.

20. The system of claim 19,
wherein each of the at least one invoked display inspection functions are operable to analyze an image of the display device acquired by the image acquisition device.

21. A computer-implemented method for creating a test executive sequence for a display inspection application, the method comprising:
displaying an image on a display, wherein the image corresponds to a display device;
displaying a display inspection test configurator which is executable to configure a set of display inspection functions in response to user input;
generating a test executive sequence based on the configured set of display inspection functions;
wherein the test executive sequence comprises a plurality of test executive steps operable to analyze the image of the display device to perform display inspection.

22. The method of claim 21, further comprising:
receiving an image of a display device being inspected; and
executing the test sequence to inspect the display device.

23. A memory medium for storing:
a library of display inspection functions;
a plurality of test executive steps, wherein each of the plurality of test executive steps is operable to perform display inspection;
a test configurator which is executable to configure a test executive sequence including one or more of the test executive steps;
program instructions executable to perform:
displaying an image of a display device on a display;
displaying the test configurator which is executable to configure the test executive sequence;
receiving user input to the test configurator to select one or more of the test executive steps, wherein each of the selected test executive steps is operable to perform display inspection;
wherein the user input in said step of receiving operates to produce a test executive sequence for analyzing the image of the display device.

24. A method for inspecting a display device, the method comprising:
configuring a display inspection algorithm comprising a plurality of display inspection functions operable to perform tests on the display device;
programmatically generating a test executive sequence that implements the display inspection algorithm; and
executing the test executive sequence to perform the tests on the display device.

25. The method of claim 24,
wherein said programmatically generating the test executive sequence comprises generating the test executive sequence without receiving user input specifying the test executive sequence.

26. The method of claim 24,
wherein said programmatically generating the test executive sequence comprises programmatically including a plurality of test executive steps for display inspection in the test executive sequence;
wherein said executing the test executive sequence comprises executing the plurality of test executive steps for display inspection to perform the tests on the display device.

27. The method of claim 24,
wherein the display inspection algorithm includes one or more display inspection functions operable to perform one or more machine vision tests on the display device;
wherein said executing the test executive sequence to perform the tests on the display device includes executing one or more test executive steps in the test executive sequence to perform the one or more machine vision tests on the display device.

28. The method of claim 27,
wherein said executing the test executive sequence to perform the tests on the display device comprises:
acquiring one or more images of the display device; and
analyzing the one or more images.

29. The method of claim 24,
wherein the display inspection algorithm includes one or more display inspection functions operable to perform one or more audio tests on the display device;
wherein said executing the test executive sequence to perform the tests on the display device includes executing one or more test executive steps in the test executive sequence to perform the one or more audio tests on the display device.

30. The method of claim 24,
wherein the display inspection algorithm includes one or more display inspection functions operable to perform one or more noise-vibration-harshness (NVH) tests on the display device;
wherein said executing the test executive sequence to perform the tests on the display device includes executing one or more test executive steps in the test executive sequence to perform the one or more noise-vibration-harshness (NVH) tests on the display device.

31. The method of claim 24,
wherein the display inspection algorithm includes one or more display inspection functions operable to perform one or more shock tests on the display device;
wherein said executing the test executive sequence to perform the tests on the display device includes executing one or more test executive steps in the test executive sequence to perform the one or more shock tests on the display device.

32. The method of claim 24,
wherein the display inspection algorithm includes one or more display inspection functions operable to perform one or more mechanical tests on the display device;
wherein said executing the test executive sequence to perform the tests on the display device includes executing one or more test executive steps in the test executive sequence to perform the one or more mechanical tests on the display device.

33. The method of claim 24,
wherein the display inspection algorithm includes one or more display inspection functions operable to perform one or more battery tests on the display device;
wherein said executing the test executive sequence to perform the tests on the display device includes executing one or more test executive steps in the test executive sequence to perform the one or more battery tests on the display device.

34. The method of claim 24,
wherein the display inspection algorithm includes one or more display inspection functions operable to perform one or more electrical tests on the display device;
wherein said executing the test executive sequence to perform the tests on the display device includes executing one or more test executive steps in the test executive sequence to perform the one or more electrical tests on the display device.

35. The method of claim 24,
wherein the display inspection algorithm includes one or more display inspection functions operable to perform one or more image processing tests on the display device;
wherein said executing the test executive sequence to perform the tests on the display device includes executing one or more test executive steps in the test executive sequence to perform the one or more image processing tests on the display device.
